(19) United States
(12) Patent Application Publication
(10) Pub. No.: US 2026/0149356 A1
(43) Pub. Date: May 28, 2026

(54) SEMICONDUCTOR DEVICE

(71) Applicant: Renesas Electronics Corporation, Tokyo (JP)

(72) Inventors: Tetsuya TAKAHASHI, Tokyo (JP); Fukashi MORISHITA, Tokyo (JP)

(73) Assignee: Renesas Electronics Corporation, Tokyo (JP)

(21) Appl. No.: 19/398,543

(22) Filed: Nov. 24, 2025

(30) Foreign Application Priority Data
Nov. 25, 2024 (JP) 2024-204922

(51) Int. Cl. H02M 1/08; H02M 3/07

(52) U.S. Cl. CPC H02M 1/08; H02M 3/07

(57) ABSTRACT

A semiconductor device capable of reducing power consumption is provided. The nMOS transistor MNo inputs the external power supply voltage Vcc into the drain and outputs the internal power supply voltage Vdd from the source. The charge pump circuit CP inputs the external power supply voltage Vcc and generates a boosted power supply voltage Vcp higher than it. The reference voltage generation circuit VREFG1 uses a replica nMOS transistor MNr formed by the same manufacturing process as the nMOS transistor MNo to generate a first reference voltage Vref1 reflecting the characteristic variations of the nMOS transistor MNo. The voltage regulator circuit VREGb applies a gate voltage VGn determined based on the first reference voltage Vref1 to the gate of the nMOS transistor MNo.

### CROSS-REFERENCE TO RELATED APPLICATION

This application claims priority under 35 U.S.C. §119 to Japanese Patent Application No. 2024-204922 filed on November 25, 2024. The disclosure of Japanese Patent Application No. 2024-204922, including the specification, drawings and abstract is incorporated herein by reference in its entirety.

### BACKGROUND

The present invention relates to a semiconductor device, for example, a semiconductor device that includes a power supply circuit.

There are disclosed techniques listed below.

Patent Document 1 Japanese Unexamined Patent Application Publication No. 2020-171076

Patent Document 1 discloses a semiconductor device that includes a switching regulator and a linear regulator. When the input voltage is applied, the switching regulator is set to a stopped state, and the linear regulator is set to an operating state. After the input voltage is applied, the switching regulator is controlled from the stopped state to the operating state.

### SUMMARY

In recent years, particularly for ICs (integrated circuits) for small devices such as smartphones and tablets, in other words, semiconductor devices, there is a demand for reducing the number of terminals and miniaturizing the package. However, reducing the number of terminals and miniaturizing the package can lead to decreased heat dissipation. Therefore, it is desirable to suppress heat generation by reducing the power consumption of semiconductor devices.

On the other hand, semiconductor devices typically use a linear regulator, or LDO (Low Drop Out) regulator, as shown in Patent Document 1, to generate an internal power supply voltage lower than the external power supply voltage. The logic circuits and the like within the semiconductor device operate on this internal power supply voltage. However, to operate the LDO regulator normally, a relatively high external power supply voltage is required. This high external power supply voltage could become a bottleneck in reducing power consumption.

The embodiments described later were made in view of such issues, and other problems and novel features will become apparent from the description of this specification and the accompanying drawings.

A semiconductor device according to one embodiment inputs an external power supply voltage and includes a power supply circuit that generates an internal power supply voltage with a voltage value lower than the external power supply voltage, and a load circuit to which the internal power supply voltage is supplied. The power supply circuit includes an n-channel output transistor, a charge pump circuit, a reference voltage generation circuit, and a voltage regulator circuit. The output transistor inputs the external power supply voltage to the drain and outputs the internal power supply voltage from the source. The charge pump circuit inputs the external power supply voltage and generates a boosted power supply voltage higher than the external power supply voltage. The reference voltage generation circuit is supplied with the boosted power supply voltage and uses a replica transistor formed by the same manufacturing process as the output transistor to generate a first reference voltage reflecting the characteristic variations of the transistor output. The voltage regulator circuit is supplied with the boosted power supply voltage and applies a gate voltage determined based on the first reference voltage to the gate of the output transistor.

According to the embodiment, the power consumption of the semiconductor device can be reduced.

### BRIEF DESCRIPTION OF THE DRAWINGS

FIG. 1A is a block diagram showing a configuration example of a semiconductor device according to one embodiment.

FIG. 1B is a schematic diagram showing an external view example of a semiconductor device according to one embodiment.

FIG. 2 is a circuit diagram showing a configuration example of a power supply circuit according to a comparative example in FIG. 1A.

FIG. 3 is a schematic diagram showing an example of the voltage values at each node according to the external power supply voltage in FIG. 2.

FIG. 4 is a schematic diagram showing an example of a problem in FIG. 2.

FIG. 5 is a circuit diagram showing a configuration example of a power supply circuit according to one embodiment in FIG. 1A.

FIG. 6A is a schematic diagram showing an example of the voltage relationship at each node in FIG. 5.

FIG. 6B is a schematic diagram showing an example of the voltage values at each node according to the external power supply voltage in FIG. 5.

FIG. 7 is a timing chart showing an example of the voltage or current occurring at each node in FIG. 5.

FIG. 8 is a circuit diagram showing a modified configuration example around the charge pump circuit in FIG. 5.

FIG. 9A is a circuit diagram showing a configuration example of a general power supply circuit in FIG. 1A.

FIG. 9B is a circuit diagram showing a configuration example of an amplifier circuit in FIG. 9A.

FIG. 10 is a schematic diagram showing an example of a problem in FIG. 9A and FIG. 9B.

FIG. 11 is a timing chart showing an example of a different problem from FIG. 10.

### DETAILED DESCRIPTION

In the following embodiments, for convenience, when necessary, the description may be divided into multiple sections or embodiments, but unless specifically stated otherwise, they are not unrelated to each other, and one is related to the other as a part or a whole modified example, detail, supplementary explanation, etc. Also, in the following embodiments, when referring to the number of elements, etc. (including the number, numerical values, quantities, ranges, etc.), unless specifically stated otherwise and clearly limited to a specific number in principle, it is not limited to that specific number and may be not less than or equal to the specific number.

Furthermore, in the following embodiments, the constituent elements (including element steps, etc.) are not necessarily essential unless specifically stated otherwise and clearly considered essential in principle. Similarly, in the following embodiments, when referring to the shapes, positional relationships, etc. of components, unless specifically stated otherwise and clearly considered not so in principle, it is assumed to include those substantially approximate or similar to such shapes, etc. The same applies to the above numerical values and ranges.

Also, in the following embodiments, a p-channel MOSFET (Metal Oxide Semiconductor Field Effect Transistor) and an n-channel MOSFET are referred to as pMOS transistors and nMOS transistors, respectively. Hereinafter, embodiments of the present invention will be described in detail with reference to the drawings. In all the drawings for explaining the embodiments, the same reference numerals are given to members having the same functions, and repetitive descriptions thereof are omitted.

### Configuration of Semiconductor Device

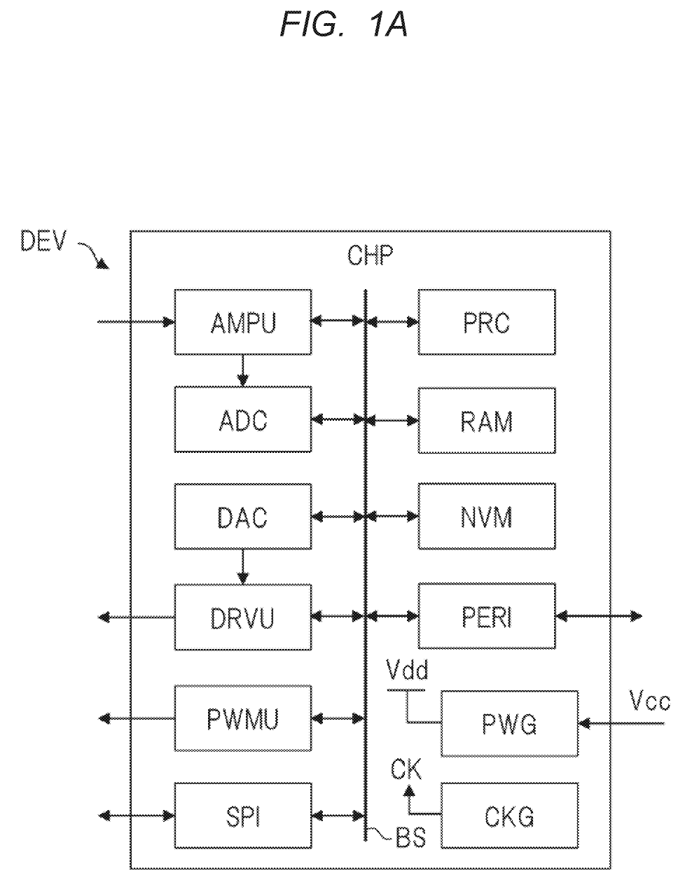

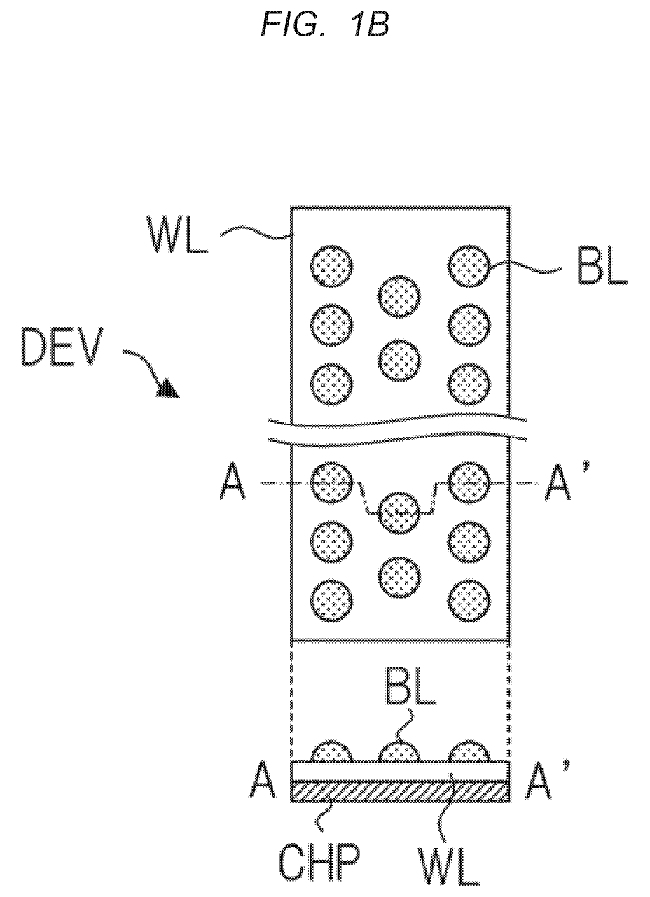

FIG. 1A is a block diagram showing a configuration example of a semiconductor device according to one embodiment. FIG. 1B is a schematic diagram showing an external view example of a semiconductor device according to one embodiment. The semiconductor device DEV shown in FIG. 1A is, for example, an SoC (System on Chip) having a semiconductor chip CHP, or a microcontroller, etc. The semiconductor device DEV includes internal units connected to each other via a bus BS. Furthermore, the semiconductor device DEV includes a power supply circuit PWG and a clock generation circuit CKG. Each of these components is formed on a single semiconductor chip CHP.

The internal units include, for example, a processor PRC, volatile memory RAM, and non-volatile memory NVM. Furthermore, the internal units include an amplifier unit AMPU, an analog-to-digital converter ADC, a digital-to-analog converter DAC, a driver unit DRVU, a PWM (Pulse Width Modulation) unit PWMU, a serial-parallel interface SPI, and various peripheral circuits PERI.

The volatile memory RAM is, for example, SRAM (Static Random Access Memory). The non-volatile memory NVM is, for example, flash memory. The processor PRC includes a CPU (Central Processing Unit) and may also include a DSP (digital signal processor) or GPU (Graphics Processing Unit), etc. The processor PRC executes a predetermined program, for example, a control program for an external system, copied from the non-volatile memory NVM to the volatile memory RAM.

As an example, the semiconductor device DEV controls an external system including sensors and actuators. In this case, the amplifier unit AMPU inputs a detection signal from the sensor, i.e., an analog signal, and amplifies the input analog signal. The analog-to-digital converter ADC converts the signal amplified by the amplifier unit AMPU into a digital signal. The processor PRC inputs the digital signal, and thus the detection signal from the sensor, via the bus BS, and generates an operation signal corresponding to the detection signal.

Then, the processor PRC outputs the generated operation signal to the digital-to-analog converter DAC or the PWM unit PWMU via the bus BS to control the actuator. In this process, the digital-to-analog converter DAC converts the digital signal input as the operation signal into an analog signal. The driver unit DRVU drives the actuator based on the analog signal from the digital-to-analog converter DAC. Alternatively, the PWM unit PWMU generates a PWM signal based on the duty ratio command value input as the operation signal and drives the actuator using the PWM signal.

The serial-parallel interface SPI performs predetermined digital communication with an external system using serial/parallel conversion. Various peripheral circuits PERI provide other functions necessary for controlling the external system. The clock generation circuit CKG generates a reference clock signal based on an external crystal oscillator, not shown, and generates a clock signal CK using a PLL (Phase Locked Loop) circuit, etc., based on the reference clock signal. The clock generation circuit CKG supplies the generated clock signal CK to the logic circuit represented by the processor PRC.

The power supply circuit PWG, as will be described in detail later, inputs the external power supply voltage Vcc supplied from the outside and generates various power supply voltages with predetermined voltage values, including the internal power supply voltage Vdd for the load circuit. The internal power supply voltage Vdd has a voltage value lower than the external power supply voltage Vcc. The load circuit is a logic circuit or an analog circuit. In the example shown in FIG. 1A, the logic circuit primarily corresponds to the processor PRC and may additionally correspond to volatile memory RAM, a serial-parallel interface SPI, or a PWM unit PWMU, among others. The analog circuit may correspond to, for example, an amplifier unit AMPU, an analog-to-digital converter ADC, and a digital-to-analog converter DAC, among others.

The semiconductor device DEV shown in FIG. 1A may be configured in a package such as the one shown in FIG. 1B. FIG. 1B illustrates a planar configuration example and a cross-sectional configuration example between A-A' of the semiconductor device DEV. In FIG. 1B, solder balls BL, which serve as package terminals, are formed on the semiconductor chip CHP via the wiring layer WL. The wiring layer WL connects the electrode pads of the semiconductor chip CHP to the solder balls BL. Such a package is referred to as a CSP (Chip Size Package), WLP (Wafer Level Package), or WLCSP (Wafer Level CSP), among others.

In particular, in semiconductor devices (DEV) for small devices such as smartphones and tablets, packages with fewer terminals and smaller sizes, like CSPs, are often used instead of QFPs (Quad Flat Packages). As a specific example, the semiconductor device DEV shown in FIGS. 1A and 1B is an IC for an OIS (Optical Image Stabilizer). In this case, the semiconductor device DEV is mounted in a small space provided around a small module that includes a camera lens.

Especially when using packages like CSPs, the heat dissipation may decrease compared to using packages that include heat dissipation components such as bonding wires or lead frames. Furthermore, the mounting space for the package is often provided in locations where heat dissipation is difficult to achieve. Therefore, it is desirable to reduce the power consumption of the semiconductor device DEV to suppress heat generation. Additionally, the external power supply voltage Vcc is supplied, for example, from a battery. To extend the battery's operating time while reducing the power consumption of the semiconductor device DEV, it is desirable for the lower limit of the external power supply voltage Vcc to be low. In the method of the embodiment described later, a power supply circuit PWG that meets such requirements is shown.

### About the Power Supply Circuit (General Configuration)

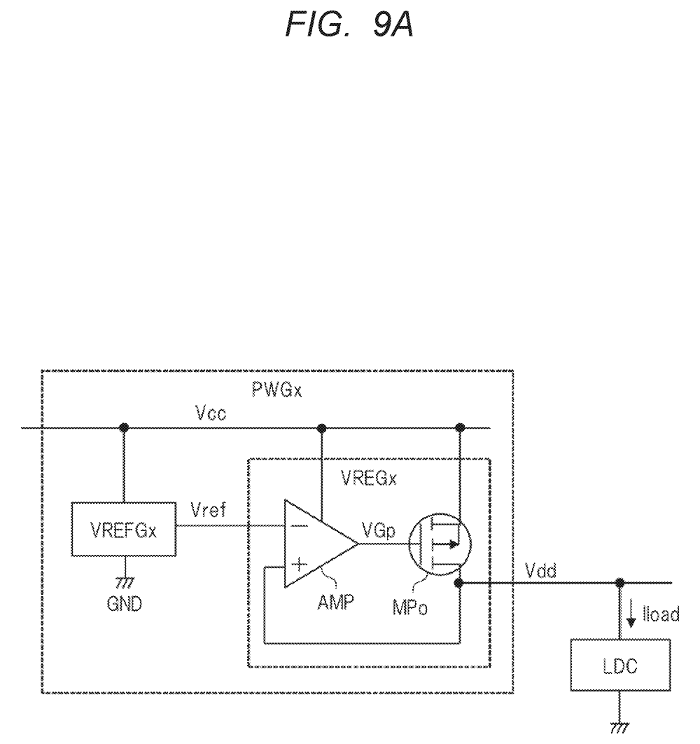

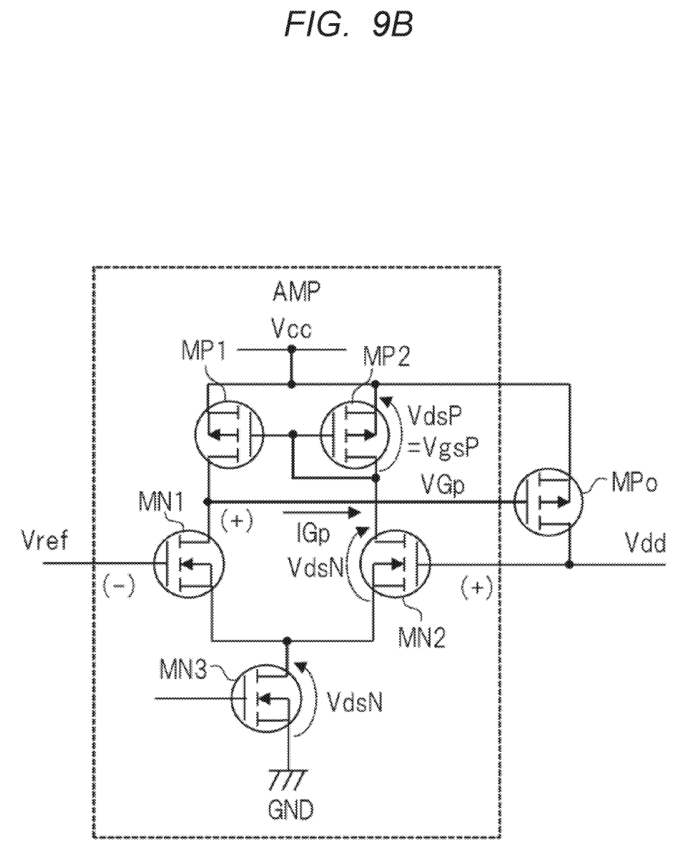

Before explaining the power supply circuit according to the embodiment, a general power supply circuit will be described first. FIG. 9A is a circuit diagram showing an example configuration of a general power supply circuit PWG in FIG. 1A. FIG. 9B is a circuit diagram showing an example configuration of the amplifier circuit AMP in FIG. 9A. The power supply circuit PWGx shown in FIG. 9A includes a reference voltage generation circuit VREFGx and a voltage regulator circuit VREGx. The reference voltage generation circuit VREFGx is configured with a bandgap reference circuit. The reference voltage generation circuit VREFGx generates a reference voltage Vref, for example, 1.2V.

The voltage regulator circuit VREGx is a linear regulator or an LDO regulator. The voltage regulator circuit VREGx includes an amplifier circuit AMP and a pMOS transistor MPo as the output transistor. The pMOS transistor MPo inputs the external power supply voltage Vcc at the source and outputs the internal power supply voltage Vdd from the drain. The amplifier circuit AMP compares the internal power supply voltage Vdd with the reference voltage Vref and controls the gate voltage VGp of the pMOS transistor MPo with negative feedback to bring the internal power supply voltage Vdd closer to the reference voltage Vref.

As a result, an internal power supply voltage Vdd of about 1.2V is generated. The internal power supply voltage Vdd is supplied to the load circuit LDC. As described in FIG. 1A, the load circuit LDC is a logic circuit, or an analog circuit formed on the semiconductor chip CHP. A relatively large load current Iload flows through the load circuit LDC. Therefore, the pMOS transistor MPo has a high current driving capability, that is, a large gate width (W).

As shown in FIG. 9B, the amplifier circuit AMP is supplied with the external power supply voltage Vcc with the ground power supply voltage GND as a reference, forming an nMOS input type differential amplifier circuit. The amplifier circuit AMP includes pMOS transistors MP1, MP2, and nMOS transistors MN1-MN3. The nMOS transistors MN1, MN2 form the differential input pair of the differential amplifier circuit. The nMOS transistor MN1 inputs the reference voltage Vref as the negative input. The nMOS transistor MN2 inputs the internal power supply voltage Vdd as the positive input.

The pMOS transistors MP1, MP2 form a current mirror circuit and serve as the load current source of the differential amplifier circuit. The pMOS transistor MP2 is configured in a diode connection. The common drain node of the pMOS transistor MP1 and the nMOS transistor MN1 becomes the positive output node of the differential amplifier circuit. The gate voltage VGp to the pMOS transistor MPo, which is the output transistor, is generated at this positive output node. The nMOS transistor MN3 is connected to the common source node of the nMOS transistors MN1, MN2 and serves as the tail current source of the differential amplifier circuit.

Here, the source-drain voltage VdsN of the nMOS transistors MN1-MN3 may need to be, for example, about 0.5V or more for stable operation of the differential amplifier circuit. Also, the gate-source voltage VgsP, and hence the source-drain voltage VdsP of the pMOS transistor MP2, may need to be, for example, 0.7V or more based on the threshold voltage, etc. In this case, the external power supply voltage Vcc may need to be 1.7V (=0.5*2+0.7) or more.

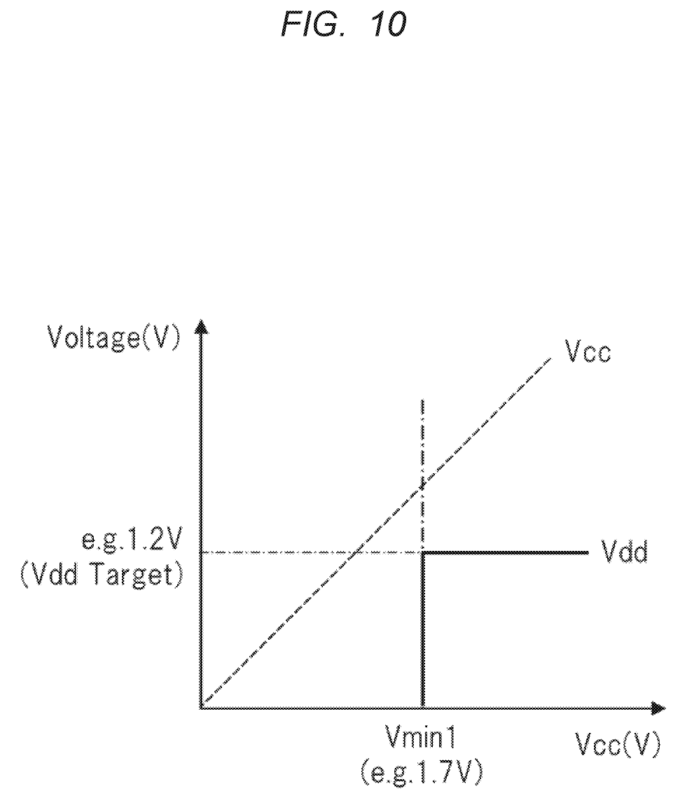

FIG. 10 is a schematic diagram showing an example of a problem in FIGS. 9A and 9B. FIG. 10 shows an example of the value of the internal power supply voltage Vdd according to the external power supply voltage Vcc. As described in FIG. 9B, to operate the amplifier circuit AMP normally, it is necessary to set a lower limit voltage Vmin1 of about 1.7V for the external power supply voltage Vcc. Therefore, as shown in FIG. 10, even if the target value of the internal power supply voltage Vdd is low, such as 1.2V, an external power supply voltage Vcc of 1.7V or more is required. This high external power supply voltage Vcc can become a bottleneck, making it difficult to reduce the power consumption of the semiconductor device DEV (A).

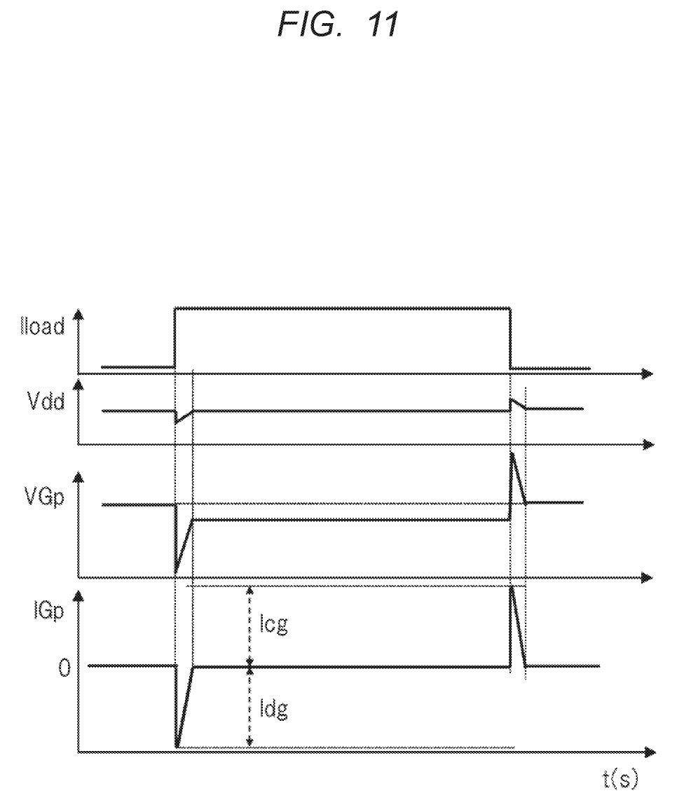

FIG. 11 is a timing chart showing an example of a problem different from that in FIG. 10. FIG. 11 shows waveform examples of the load current Iload, internal power supply voltage Vdd, gate voltage VGp, and gate current IGp in FIG. 9B. As shown in FIG. 11, when the load current Iload increases or decreases rapidly, the internal power supply voltage Vdd decreases or increases momentarily. The amplifier circuit AMP suppresses the fluctuation of the internal power supply voltage Vdd quickly by rapidly decreasing or increasing the gate voltage VGp in response to the momentary decrease or increase of the internal power supply voltage Vdd.

Here, the amplifier circuit AMP needs to pass a large gate current, i.e., a large gate capacitance, quickly to rapidly decrease or increase the gate voltage VGp. Therefore, the amplifier circuit AMP may consume a relatively large amount of power (B). Furthermore, the transistors constituting the amplifier circuit AMP require a relatively high current driving capability, that is, a relatively large gate width (W). As a result, the amplifier circuit AMP (C) may have a relatively large power consumption.

### About the Power Supply Circuit (Comparative Example)

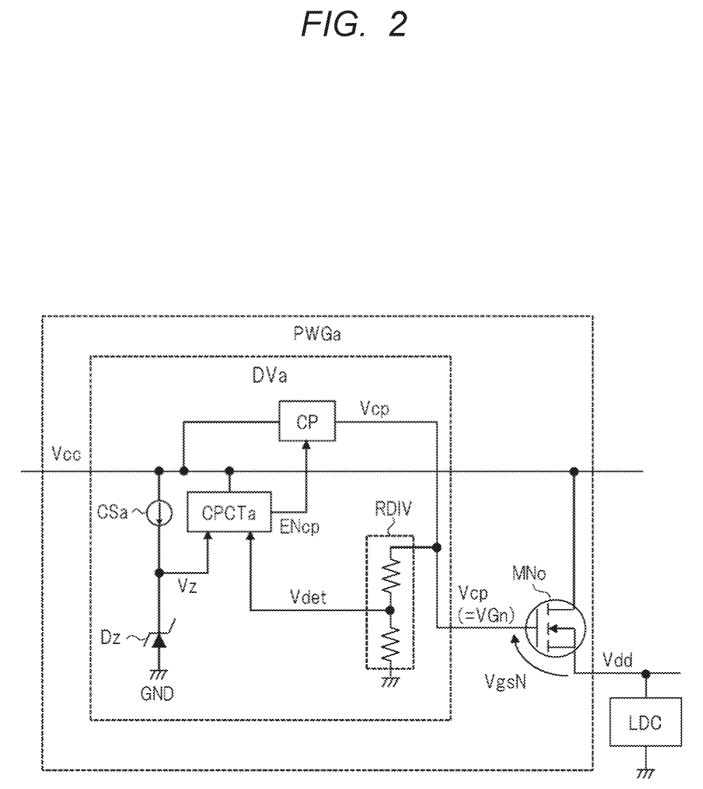

Next, a description will be given of the power supply circuit according to the comparative example, which was considered prior to the power supply circuit according to the embodiment. FIG. 2 is a circuit diagram showing an example of the configuration of the power supply circuit PWG according to the comparative example in FIG. 1A. The power supply circuit PWGa shown in FIG. 2 includes an nMOS transistor MNo, which is an output transistor, and a drive circuit DVa that drives the nMOS transistor MNo.

As such, in FIG. 2, an nMOS transistor MNo is used as the output transistor instead of the pMOS transistor MPo shown in FIG. 9A. The nMOS transistor MNo inputs the external power supply voltage Vcc into the drain and outputs the internal power supply voltage Vdd from the source. In other words, the nMOS transistor MNo constitutes a source follower circuit. If the current driving capability is the same, using an nMOS transistor instead of a pMOS transistor can reduce the circuit area.

The drive circuit DVa includes a charge pump circuit CP, a charge pump control circuit CPCTa, a current source CSa, a Zener diode Dz, and a resistive voltage divider circuit RDIV. The charge pump circuit CP inputs the external power supply voltage Vcc and generates a boosted power supply voltage Vcp higher than the external power supply voltage Vcc. The resistive voltage divider circuit RDIV generates a detection voltage Vdet reflecting the boosted power supply voltage Vcp by resistively dividing the boosted power supply voltage Vcp.

The current source CSa and the Zener diode Dz are connected in series between the external power supply voltage Vcc and the ground power supply voltage GND. This generates a Zener voltage Vz at one end of the Zener diode Dz. The Zener voltage Vz is a reference voltage for determining the value of the boosted power supply voltage Vcp. The charge pump control circuit CPCTa compares the detection voltage Vdet with the Zener voltage Vz. Based on the comparison result, the charge pump control circuit CPCTa controls the charge pump circuit CP to be in an active or inactive state using the enable signal ENcp.

Specifically, the charge pump control circuit CPCT activates the charge pump circuit CP when "Vdet < Vz" and deactivates it when "Vdet > Vz". This maintains the boosted power supply voltage Vcp at a predetermined value determined by the resistive voltage division ratio of the resistive voltage divider circuit RDIV and the Zener voltage Vz. The nMOS transistor MNo, which is the output transistor, inputs the boosted power supply voltage Vcp generated in this manner as the gate voltage VGn. The nMOS transistor MNo then outputs a voltage that is reduced by the gate-source voltage VgsN from the gate voltage VGn as the internal power supply voltage Vdd.

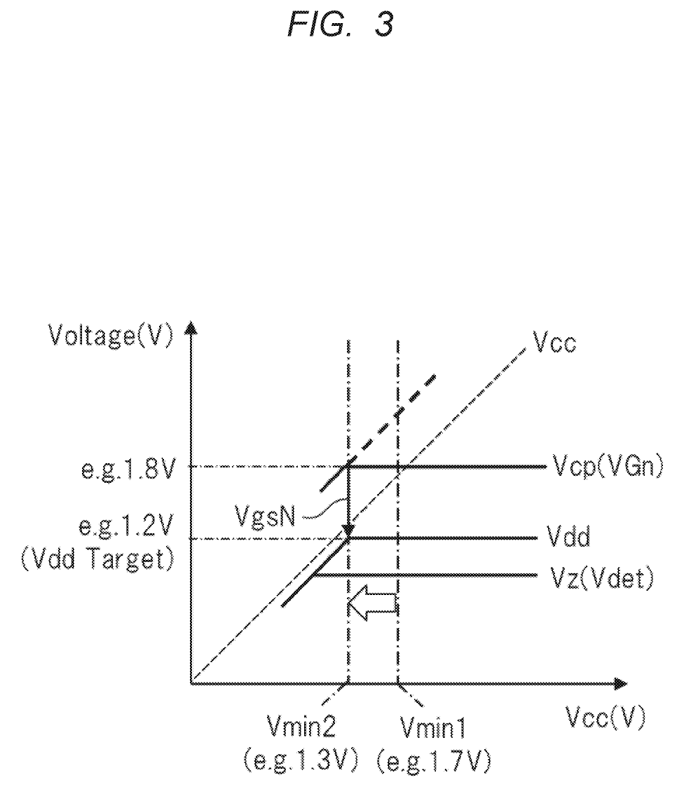

FIG. 3 is a schematic diagram showing an example of the voltage values at each node corresponding to the external power supply voltage Vcc in FIG. 2. FIG. 3 shows an example of the voltage values of the boosted power supply voltage Vcp, the internal power supply voltage Vdd, and the Zener voltage Vz. As shown in FIG. 3, by using the power supply circuit PWGa shown in FIG. 2, the lower limit voltage Vmin2 of the external power supply voltage Vcc can be reduced to the required internal power supply voltage Vdd, for example, about 1.2V. In this example, the lower limit voltage Vmin2 is 1.3V, which is lower than the lower limit voltage Vmin1 shown in FIG. 10, for example, 1.7V.

In the range above this lower limit voltage Vmin2, the boosted power supply voltage Vcp is maintained at, for example, 1.8V based on the Zener voltage Vz of about 0.9V and a resistive voltage division ratio of about 1/2. The nMOS transistor MNo inputs this boosted power supply voltage Vcp of about 1.8V as the gate voltage VGn and outputs a voltage reduced by the gate-source voltage VgsN of about 0.6V as the internal power supply voltage Vdd.

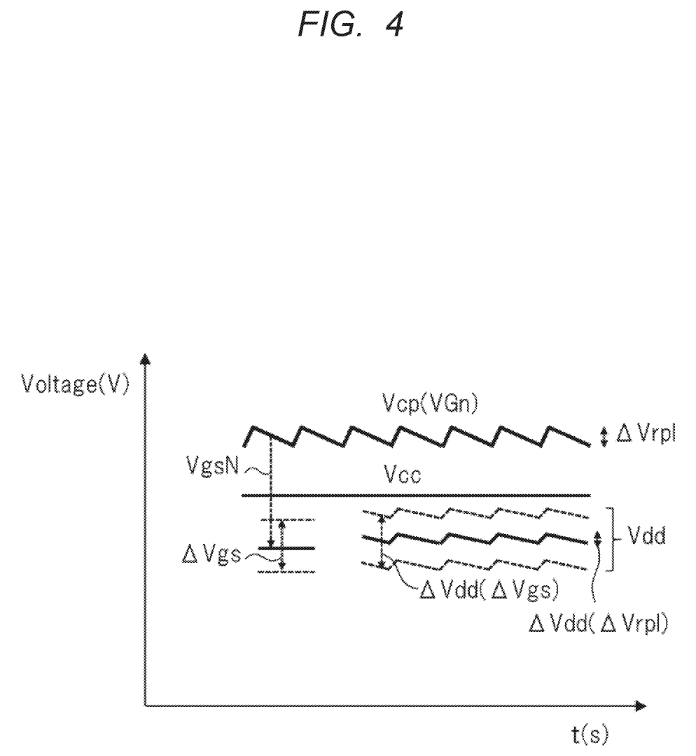

FIG. 4 is a schematic diagram showing an example of the issues in FIG. 2. FIG. 4 shows an example of the temporal transition of the boosted power supply voltage Vcp and the internal power supply voltage Vdd. The charge pump circuit CP typically generates the boosted power supply voltage Vcp by alternately repeating the charging operation to the capacitor and the boosting operation to the capacitor. Therefore, the boosted power supply voltage Vcp usually includes a ripple voltage ΔVrpl. Additionally, the gate-source voltage VgsN of the nMOS transistor MNo may experience voltage fluctuations ΔVgs, such as ±50mV to ±200mV, depending on manufacturing variations or temperature changes.

As a result, the internal power supply voltage Vdd may experience voltage fluctuations ΔVdd(ΔVrpl) corresponding to the ripple voltage ΔVrpl. Furthermore, the internal power supply voltage Vdd may also experience voltage fluctuations ΔVdd(ΔVgs) corresponding to the voltage fluctuations ΔVgs of the gate-source voltage VgsN. This makes it difficult to determine the internal power supply voltage Vdd with high precision in the method of the comparative example shown in FIG. 2.

### About the Power Supply Circuit (Embodiment)

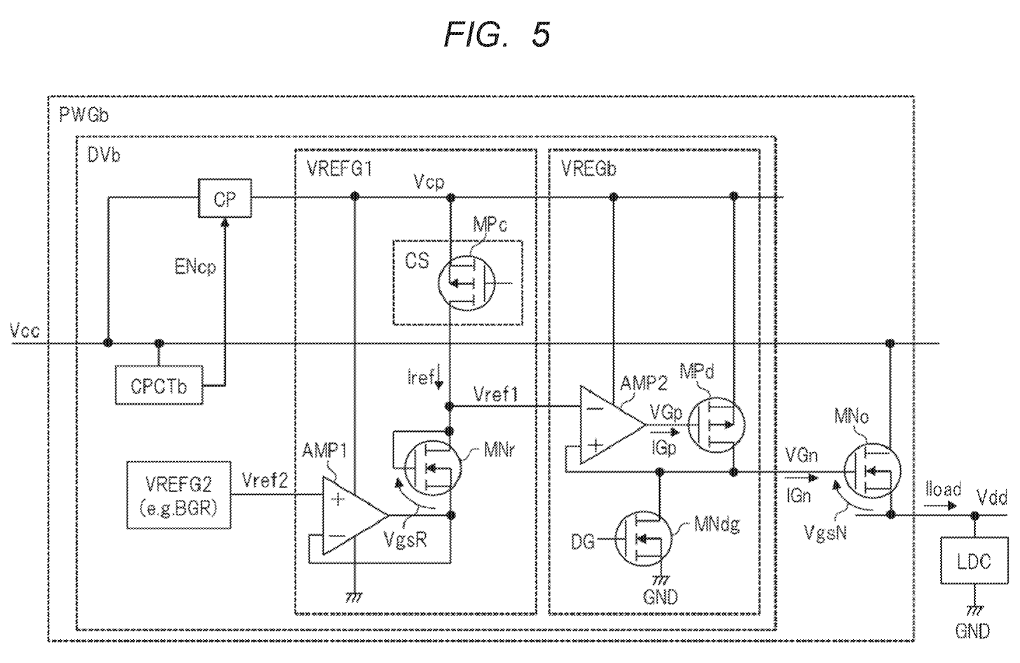

FIG. 5 is a circuit diagram showing an example of the configuration of the power supply circuit PWG according to one embodiment in FIG. 1A. The power supply circuit PWGb shown in FIG. 5 inputs the external power supply voltage Vcc and generates an internal power supply voltage Vdd with a voltage value lower than the external power supply voltage Vcc. The power supply circuit PWGb includes an nMOS transistor MNo, which is an output transistor, and a drive circuit DVb that controls the nMOS transistor MNo. The nMOS transistor MNo inputs the external power supply voltage Vcc to the drain and outputs the internal power supply voltage Vdd from the source, as in the case of FIG. 2. On the other hand, the drive circuit DVb has a different configuration from that in FIG. 2.

The drive circuit DVb includes a charge pump circuit CP, a charge pump control circuit CPCTb, two reference voltage generation circuits VREFG1 and VREFG2, and a voltage regulator circuit VREGb. The charge pump circuit CP inputs the external power supply voltage Vcc and generates a boosted power supply voltage Vcp higher than the external power supply voltage Vcc. The charge pump control circuit CPCTb controls the charge pump circuit CP to be in an active or inactive state using, for example, the enable signal ENcp.

The reference voltage generation circuit VREFG2 is, for example, a bandgap reference circuit BGR, which generates a second reference voltage Vref2 that does not have temperature dependency. On the other hand, the boosted power supply voltage Vcp is supplied to the reference voltage generation circuit VREFG1. The reference voltage generation circuit VREFG1 includes a replica transistor, specifically an nMOS transistor MNr, formed using the same manufacturing process as the output transistor, which is an nMOS transistor MNo. The reference voltage generation circuit VREFG1, in outline, generates a first reference voltage Vref1 that reflects the characteristic variations of the output transistor using the replica transistor, which is the nMOS transistor MNr.

In detail, the reference voltage generation circuit VREFG1 includes, in addition to the nMOS transistor MNr, a current source CS and an amplifier circuit (first amplifier circuit) AMP1. The current source CS is supplied with the boosted power supply voltage Vcp at one end and generates a reference current Iref to flow through the nMOS transistor MNr. The current source CS is constituted, for example, by a pMOS transistor-type current mirror circuit including a pMOS transistor MPc, which is a mirror transistor. The nMOS transistor MNr is configured in a diode connection. The nMOS transistor MNr generates a gate-source voltage VgsR between the commonly connected drain and gate and the source by having the reference current Iref flow between the drain and source.

The amplifier circuit AMP1 is supplied with the boosted power supply voltage Vcp. The amplifier circuit AMP1 applies the second reference voltage Vref2 from the reference voltage generation circuit VREFG2 to the source of the nMOS transistor MNr. In detail, the amplifier circuit AMP1 is constituted, for example, by a voltage follower circuit that takes the second reference voltage Vref2 as the positive input. This voltage follower circuit applies an output voltage of the same magnitude as the second reference voltage Vref2 to the source of the nMOS transistor MNr. The amplifier circuit AMP1 is constituted, for example, using a differential amplifier circuit as shown in FIG. 9B. Therefore, to stabilize the operation of the amplifier circuit AMP1, a boosted power supply voltage Vcp of, for example, 1.7V or more is required.

The first reference voltage Vref1 is generated at the gate and drain of the nMOS transistor MNr. Specifically, the reference voltage generation circuit VREFG1 generates the first reference voltage Vref1 by adding the gate-source voltage VgsR generated in the nMOS transistor MNr to the second reference voltage Vref2. The second reference voltage Vref2 is set, for example, to 1.2V based on the target value of the internal power supply voltage Vdd. The gate-source voltage VgsR is approximately 0.6V, based on the threshold voltage value of the nMOS transistor MNr and the value of the reference current Iref. In this case, the first reference voltage Vref1 becomes approximately 1.8V.

The boosted power supply voltage Vcp is supplied to the voltage regulator circuit VREGb. The voltage regulator circuit VREGb, in outline, applies a gate voltage VGn, determined based on the first reference voltage Vref1, to the gate of the output transistor, which is the nMOS transistor MNo. In detail, the voltage regulator circuit VREGb includes a driving transistor, which is a pMOS transistor MPd, an amplifier circuit AMP2, and a discharge transistor, which is an nMOS transistor MNdg.

The pMOS transistor MPd forms a source-drain path between the boosted power supply voltage Vcp and the gate of the output transistor, which is the nMOS transistor MNo. The amplifier circuit AMP2 performs negative feedback control of the gate voltage VGp of the pMOS transistor MPd to bring the error between the gate voltage VGn of the nMOS transistor MNo, which is also the drain voltage of the pMOS transistor MPd, and the first reference voltage Vref1 close to zero.

The discharge transistor, which is the nMOS transistor MNdg, discharges the gate voltage VGn of the nMOS transistor MNo towards the ground power supply voltage GND in response to the discharge instruction signal DG. The amplifier circuit AMP2 is constituted, for example, using a differential amplifier circuit as shown in FIG. 9B. Similar to the case of the amplifier circuit AMP1, a boosted power supply voltage Vcp of, for example, 1.7V or more is required to stabilize the operation of the amplifier circuit AMP2.

With such a voltage regulator circuit VREGb, a gate voltage VGn of approximately 1.8V, for example, is applied to the gate of the output transistor, which is the nMOS transistor MNo, based on the first reference voltage Vref1. The value of the internal power supply voltage Vdd becomes the value obtained by subtracting the gate-source voltage VgsN of the nMOS transistor MNo from the gate voltage VGn. For example, when the gate-source voltage VgsN is approximately 0.6V, the internal power supply voltage Vdd becomes approximately 1.2V.

In detail, the nMOS transistor MNo has sufficiently high current driving capability, that is, a sufficiently large gate width (W), according to the value of the required load current Iload. In this case, the overdrive voltage Vov (=VgsN-Vth) that occurs according to the load current Iload can be, for example, 0.1V or less. When the threshold voltage (Vth) of the nMOS transistor MNo is approximately 0.5V, the gate-source voltage VgsN can be approximately 0.6V.

The charge pump control circuit CPCTb controls the charge pump circuit CP so that the boosted power supply voltage Vcp is above the lower voltage limit and below the upper limit voltage. The lower limit voltage of the boosted power supply voltage Vcp is the higher of the following two voltages. The first voltage is the voltage required for the stable operation of the amplifier circuits AMP1 and AMP2, as mentioned above, for example, 1.7V. The second voltage is the required gate voltage VGn, which is the target internal power supply voltage Vdd, for example, 1.2V, plus the gate-source voltage VgsN, for example, 0.6V. That is, to operate the pMOS transistor MPd normally, the relationship "Vcp > VGn" must be satisfied.

Furthermore, the gate-source voltage VgsN can be appropriately changed according to the threshold voltage (Vth) setting and size setting of the nMOS transistor MNo. Correspondingly, the lower limit voltage of the boosted power supply voltage Vcp can also change. On the other hand, the upper limit voltage of the boosted power supply voltage Vcp is determined, for example, considering power consumption and the breakdown voltage of the transistors. The charge pump control circuit CPCTb deactivates the charge pump circuit CP using the enable signal ENcp when the boosted power supply voltage Vcp reaches the upper limit voltage.

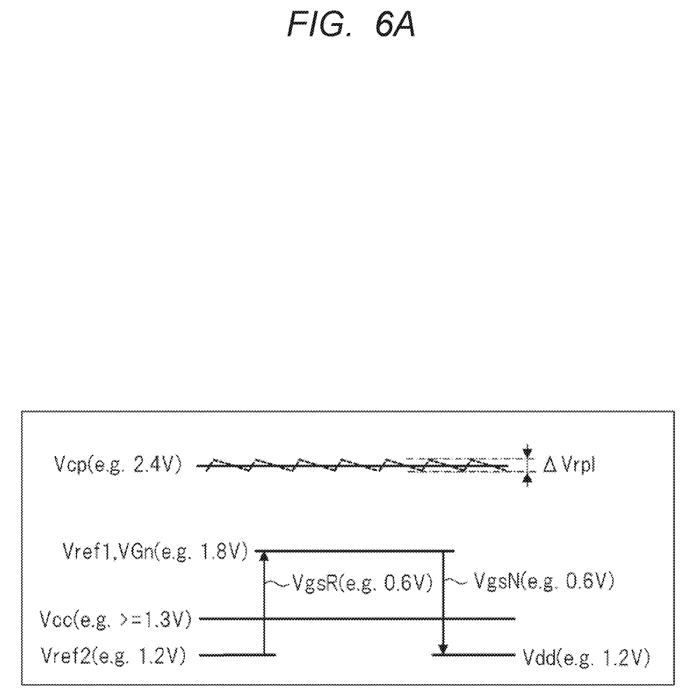

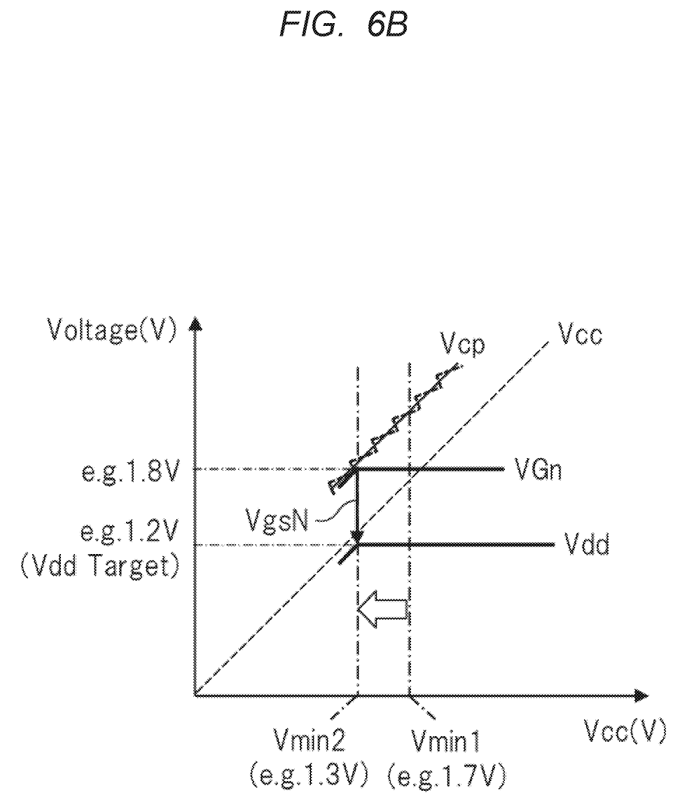

FIG. 6A is a schematic diagram showing an example of the voltage relationship of each node in FIG. 5. In FIG. 6A, the second reference voltage Vref2 is set to, for example, 1.2V. The first reference voltage Vref1 is set to, for example, 1.8V by adding the gate-source voltage VgsR of the replica transistor (MNr) to the second reference voltage Vref2. Accordingly, the gate voltage VGn to the output transistor (MNo) also becomes 1.8V. The internal power supply voltage Vdd becomes 1.2V due to the voltage drop of the gate-source voltage VgsN of the output transistor (MNo) with respect to the gate voltage VGn.

In this example, the boosted power supply voltage Vcp is 2.4V. As shown in FIG. 6A, a predetermined ripple voltage ΔVrpl is superimposed on the boosted power supply voltage Vcp, which is based on 2.4V, etc. However, the reference voltage generation circuit VREFG1 can generate a stable first reference voltage Vref1 even if the ripple voltage ΔVrpl is included in the boosted power supply voltage Vcp, due to the rectifying action by the current source CS and the rectifying action by the amplifier circuit AMP1 constituting the voltage follower circuit.

Similarly, the voltage regulator circuit VREGb can generate a stable gate voltage VGn even if the ripple voltage ΔVrpl is included in the boosted power supply voltage Vcp, due to the rectifying action of the amplifier circuit AMP2 having a negative feedback configuration. As a result, the output transistor (MNo) can generate a stable internal power supply voltage Vdd. That is, it is possible to suppress the voltage fluctuation ΔVdd (ΔVrpl) of the internal power supply voltage Vdd according to the ripple voltage ΔVrpl, as described in FIG. 4.

The nMOS transistor MNr, which is a replica transistor, is configured with a gate width (W) of 1/K of the nMOS transistor MNo, which is an output transistor. Accordingly, the reference current Iref from the current source CS is also set to a value of 1/K of the load current Iload assumed for the load circuit LDC. The value of K is 10 or more and may be on the order of 100 or 1000. The assumed load current Iload is, for example, an average current or rated current expected in advance in the load circuit LDC.

With such parameter settings, if the gate-source voltage VgsN of the nMOS transistor MNo varies due to manufacturing variations or temperature changes, the gate-source voltage VgsR of the nMOS transistor MNr also varies similarly. As a result, it is possible to maintain the state of "VgsR=VgsN" against various variation factors, so the value of the internal power supply voltage Vdd can be determined by the value of the second reference voltage Vref2. This makes it possible to suppress the voltage fluctuation ΔVdd (ΔVgs) of the internal power supply voltage Vdd due to manufacturing variations or temperature changes of the nMOS transistor MNo, as described in FIG. 4. Furthermore, the area overhead associated with the nMOS transistor MNr and the current source CS can also be reduced.

FIG. 6B is a schematic diagram showing an example of the voltage values of each node according to the external power supply voltage Vcc in FIG. 5. As shown in FIG. 6B, by using the power supply circuit PWGb shown in FIG. 5, the external power supply voltage Vcc required to generate the internal power supply voltage Vdd of 1.2V can be lowered to a lower limit voltage Vmin2 of about 1.3V, similar to the case of FIG. 3. That is, the external power supply voltage Vcc can be lowered from the lower limit voltage Vmin1 of about 1.7V shown in FIG. 10 to the lower limit voltage Vmin2 of about 1.3V. Note that depending on the gate width (W) of the output transistor (MNo), it is also possible to set the lower limit voltage Vmin2 to a value closer to 1.2V.

By lowering the external power supply voltage Vcc in this way, it is possible to reduce the power consumption of the semiconductor device DEV, unlike the case of FIG. 10. Furthermore, when the external power supply voltage Vcc is supplied from a battery, it is possible to extend the battery's operating time. Note that in FIG. 6B, the boosted power supply voltage Vcp rises with the rise of the external power supply voltage Vcc according to the boost ratio of the charge pump circuit CP. Also, the gate voltage VGn is set to 1.8V, etc., when the boosted power supply voltage Vcp exceeds the lower limit voltage of the aforementioned boosted power supply voltage Vcp.

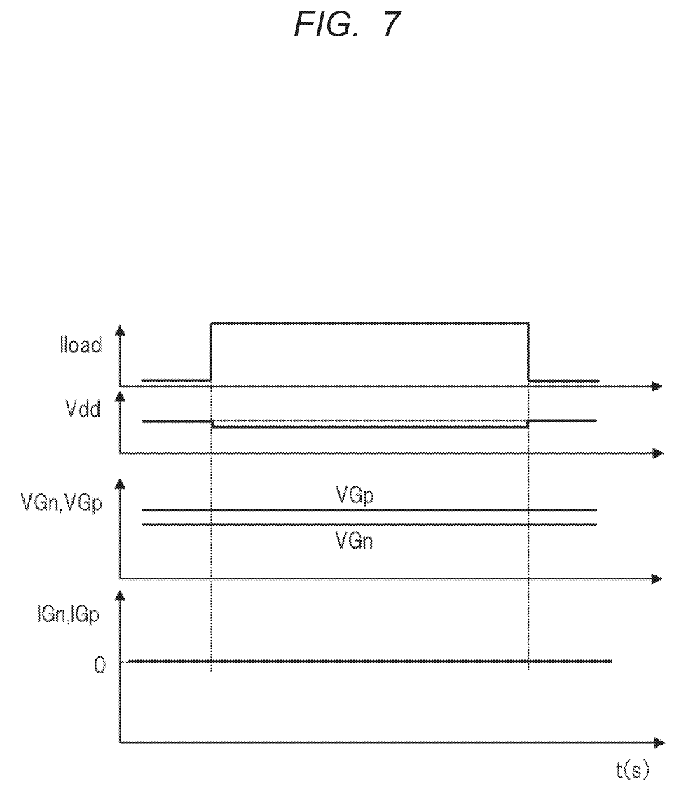

FIG. 7 is a timing chart showing an example of the voltage or current occurring at each node in FIG. 5. FIG. 7 shows waveform examples of the load current Iload, internal power supply voltage Vdd, gate voltages VGn, VGp, and gate currents IGn, IGp in FIG. 5. As shown in FIG. 7, when the load current Iload increases, the internal power supply voltage Vdd may slightly decrease according to the current driving capability of the nMOS transistor MNo. On the other hand, the voltage regulator circuit VREGb generates the gate voltage VGn in an open loop. Therefore, unlike the case of FIG. 11, the gate voltage VGn is constant. Consequently, the gate voltage VGp is also constant.

When the gate voltages VGn and VGp are constant, the gate currents IGn and IGp are both approximately zero. That is, unlike the case of FIG. 11, since the gate current IGp is approximately zero, the amplifier circuit AMP2 does not require high current driving capability. Furthermore, the amplifier circuit AMP2 does not require high-speed responsiveness. As a result, it is possible to reduce the power consumption of the amplifier circuit AMP2. Also, the amplifier circuit AMP2 can operate stably with the boosted power supply voltage Vcp, which has low current supply capability, without using the external power supply voltage Vcc. Furthermore, it is possible to reduce the circuit area of the amplifier circuit AMP2. Note that these effects are also similar for the amplifier circuit AMP1.

### Modified Example Around Charge Pump Circuit

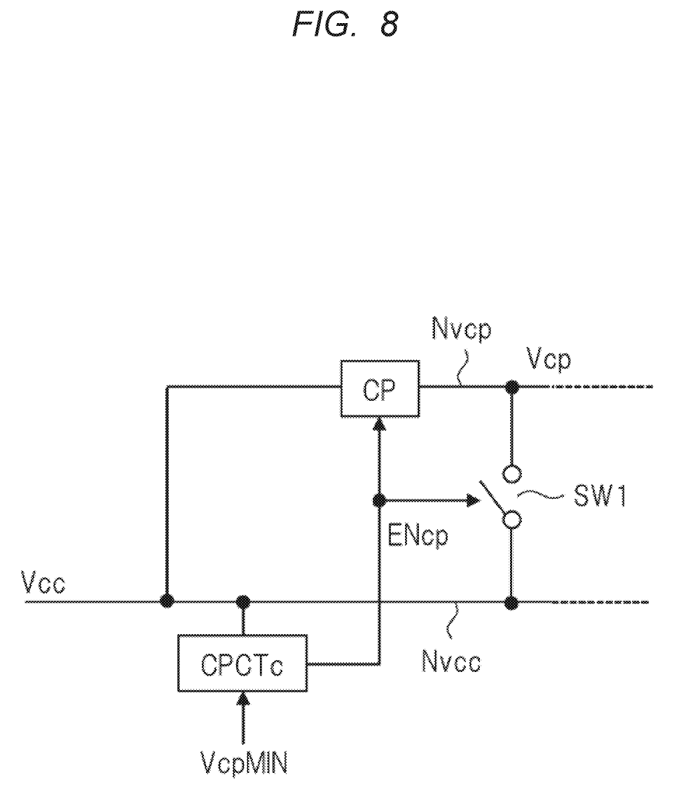

FIG. 8 is a circuit diagram showing a modified configuration example around the charge pump circuit CP in FIG. 5. FIG. 8 shows the configuration around the charge pump circuit CP extracted and displayed. In FIG. 8, in addition to the charge pump circuit CP and the charge pump control circuit CPCTc, a switch SW1 is provided. The charge pump control circuit CPCTc compares the external power supply voltage Vcc with the predetermined lower limit voltage VcpMIN of the boosted power supply voltage Vcp. Then, the charge pump control circuit CPCTc deactivates the charge pump circuit CP using the enable signal ENcp when the external power supply voltage Vcc exceeds the lower limit voltage VcpMIN.

The switch SW1 connects the node Nvcc of the external power supply voltage Vcc to the node Nvcp of the boosted power supply voltage Vcp when the external power supply voltage Vcc exceeds the lower limit voltage VcpMIN. In this example, the charge pump control circuit CPCTc controls the switch SW1 to be on when deactivating the charge pump circuit CP. As a result, the boosted power supply voltage Vcp is substituted by the external power supply voltage Vcc. Note that if the external power supply voltage Vcc does not exceed the lower limit voltage VcpMIN, the charge pump circuit CP is controlled to be active, and the switch SW1 is controlled to be off.

By using such a configuration, when the external power supply voltage Vcc is sufficiently large, the charge pump circuit CP can be kept inactive, thereby further reducing the power consumption of the semiconductor device DEV. Note that the switch SW1 may be configured, for example, with a pMOS transistor. The charge pump control circuit CPCTc may be configured, for example, with a comparator that compares the external power supply voltage Vcc divided by resistors with a lower limit voltage VcpMIN corresponding to the resistor division ratio.

### Other Modified Examples

In FIG. 5, a pMOS transistor MPd is used as the driving transistor in the voltage regulator circuit VREGb. However, it is also possible to use an nMOS transistor instead of a pMOS transistor. In this case, the amplifier circuit AMP2 is configured with a pMOS input-type differential amplifier circuit instead of the nMOS input-type differential amplifier circuit shown in FIG. 9B.

Additionally, the power supply circuit PWGb shown in FIG. 5 is configured to equalize the second reference voltage Vref2 and the internal power supply voltage Vdd. However, it is also possible to provide a constant voltage difference between the second reference voltage Vref2 and the internal power supply voltage Vdd by feeding back the value of the internal power supply voltage Vdd divided by resistors to the amplifier circuit AMP2.

### Main Effects of the Embodiment

As described above, a semiconductor device, according to one embodiment, uses an n-channel type output transistor that constitutes a source follower circuit to generate an internal power supply voltage from an external power supply voltage. This allows the external power supply voltage to be lowered to the same level as the internal power supply voltage, thereby reducing power consumption in the semiconductor device. Furthermore, a reference voltage generation circuit and a voltage regulator circuit are provided to generate the gate voltage of the output transistor. These circuits generate the gate voltage in an open loop, so current driving capability is not required. As a result, power consumption in the reference voltage generation circuit and the voltage regulator circuit can also be reduced.

Although the invention made by the inventor has been specifically described based on the embodiment, the present invention is not limited to the described embodiment and can be variously modified without departing from the gist thereof. For example, the described embodiment is detailed to clearly explain the invention and is not necessarily limited to including all the configurations described. It is also possible to replace part of the configuration of one embodiment with the configuration of another embodiment, or to add the configuration of another embodiment to the configuration of one embodiment. Additionally, it is possible to add, delete, or replace part of the configuration of each embodiment with other configurations.

What is claimed is:

1. A semiconductor device comprising:
a power supply circuit that inputs an external power supply voltage and generates an internal power supply voltage having a voltage value lower than the external power supply voltage; and
a load circuit to which the internal power supply voltage is supplied,
wherein the power supply circuit includes:
an n-channel type output transistor that inputs the external power supply voltage to the drain and outputs the internal power supply voltage from the source;
a charge pump circuit that inputs the external power supply voltage and generates a boosted power supply voltage higher than the external power supply voltage;
a reference voltage generation circuit that is supplied with the boosted power supply voltage and has a replica transistor formed by the same manufacturing process as the output transistor, and generates a first reference voltage reflecting the characteristic variations of the output transistor using the replica transistor; and
a voltage regulator circuit that is supplied with the boosted power supply voltage and applies a gate voltage determined based on the first reference voltage to the gate of the output transistor.

2. The semiconductor device according to claim 1, wherein the replica transistor has a gate width of 1/K of the output transistor, and the value of K is 10 or more.

3. The semiconductor device according to claim 2,
wherein the replica transistor is configured in a diode connection, and
wherein the reference voltage generation circuit further includes a current source that generates a reference current flowing through the replica transistor, and generates the first reference voltage by adding the gate-source voltage generated in the replica transistor to a second reference voltage that does not have temperature dependency.

4. The semiconductor device according to claim 3, wherein the reference current is set to a value of 1/K of the load current assumed for the load circuit.

5. The semiconductor device according to claim 3,
wherein the reference voltage generation circuit includes a first amplifier circuit to which the boosted power supply voltage is supplied, and
wherein the first amplifier circuit inputs the second reference voltage and applies a voltage of the same magnitude as the second reference voltage to the source of the replica transistor.

6. The semiconductor device according to claim 1,
wherein the voltage regulator circuit includes:
a driving transistor that forms a source-drain path between the boosted power supply voltage and the gate of the output transistor; and
a second amplifier circuit that performs negative feedback control of the gate voltage of the driving transistor to bring the error between the gate voltage of the output transistor and the first reference voltage close to zero.

7. The semiconductor device according to claim 1, further comprising:
a charge pump control circuit that deactivates the charge pump circuit when the external power supply voltage exceeds a predetermined lower limit voltage of the boosted power supply voltage; and
a switch element that connects the node of the external power supply voltage to the node of the boosted power supply voltage when the external power supply voltage exceeds the lower limit voltage of the boosted power supply voltage.
